(19) United States
(12) Patent Application Publication
(10) Pub. No.: US 2024/0327681 A1
(43) Pub. Date: Oct. 3, 2024

(54) BONDING SYSTEM

(71) Applicant: DDP SPECIALTY ELECTRONIC MATERIALS US, LLC, Wilmington, DE (US)

(72) Inventors: Stefan Dehnicke, Seeheim-Jugenheim (DE); Gerd Becker, Frankfurt (DE); Anna Osichow, Hofheim am Taunus (DE); Philipp Zutavern, Frankfurt (DE); David Kistner, Schwalbach (DE)

(21) Appl. No.: 18/742,857

(22) Filed: Jun. 13, 2024

Related U.S. Application Data
(63) Continuation of application No. 17/265,951, filed on Feb. 4, 2021.

(51) Int. Cl. C09J 11/06; C08K 5/32; C09J 5/02; C09J 5/06; C09J 11/08; C09J 111/00; C09J 115/02; C09J 123/28; C09J 123/34

(52) U.S. Cl. CPC C09J 11/06; C09J 5/02; C09J 5/06; C09J 11/08; C09J 111/00; C09J 115/02; C09J 123/28; C09J 123/34; C08K 5/32; C09J 2301/504; C09J 2400/163; C09J 2400/166; C09J 2411/00; C09J 2415/00; C09J 2421/006; C09J 2421/008; C09J 2423/00

(57) ABSTRACT

A water-based adhesive film-forming cover composition including: (i) at least one film forming polymer; (ii) at least one lower crystallinity first polynitroso compound; (iii) at least one higher crystallinity second polynitroso compound; (iv) at least one crosslinking agent; and (v) water as a carrier liquid; a bonding system including a combination of: (a) a water-based primer component; and (b) the above water-based cover component; a process for manufacturing the above bonding system; and a process of manufacturing a bonded article with the above bonding system. A bonded article, having a bonding line made from the above bonding system disposed between metal and rubber substrates, exhibits excellent stability against an aqueous urea-solution at temperatures of up to about 95° C.

### FIELD

This application claims priority to U.S. patent application Ser. No. 17/265,951, filed on Feb. 4, 2021, which claimed priority to International Application No. PCT/US19/044846, filed on Aug. 2, 2019, which claimed priority to U.S. Patent Application Ser. No. 62/714,999, filed on Aug. 6, 2018. All parent applications are incorporated herein by reference in their entireties.

The present invention relates to a bonding system also referred to herein as a cover composition; and more specifically, the present invention relates to a water-based, cover composition particularly useful for bonding two dissimilar substrates to form a bonded composite unit in combination with a water-based primer; the bonding system advantageously exhibits an increased resistance to attack by an aqueous urea solution to the integrity of the bond between the two substrates.

### BACKGROUND

With new environmental regulations and increasing air pollution, exhaust gas treatment for diesel engines is continuously gaining importance. Due to rapidly increasing vehicle traffic, the demand for exhaust gas treatment products is rising. Some known exhaust gas treatment systems include for example selective catalytic reduction (SCR) systems. Stricter governmental restrictions on nitrogen oxide (NOx) limits, according to the Euro 6 standard as well as the upcoming real driving emissions (RDE) tests, are further posing a major challenge to car manufacturers. RDE tests measure the exhaust gas emissions of vehicles under realistic driving conditions. This means that low emission values obtained under laboratory conditions will no longer be sufficient to pass exhaust gas emissions regulations. These tough regulations require more than simply optimizing diesel engines, and therefore, makes additional exhaust gas treatment an absolutely necessity for passing the current exhaust gas emissions regulations.

One key technology for the reduction of nitrogen oxides is the use of a SCR system. A major part of diesel vehicles with the Euro 6 exhaust standard are currently fitted with a SCR system. An aqueous solution of urea in the concentration of 32.5% (a eutectic mixture) is widely used in mobile urea SCR systems. SCR systems use water-based urea solutions as an ammonia (NH₃) source to neutralize the nitrogen oxides present in exhaust emissions of diesel engines. For example, a known aqueous urea-solution, available under the tradename AdBlue®, is used in urea SCR systems as an ammonia source. The ammonia in the urea-solution reacts selectively with nitrogen oxides to form nitrogen (N₂) and water. The transportation of urea/ammonia from storage tanks to the exhaust system requires equipment parts made of specific materials than can withstand degradation from contact with a urea-solution such as AdBlue®. Typically, such equipment parts are composite parts made by bonding together two dissimilar materials such as rubber and metal. Usually, the rubber materials for this use are specially designed rubber materials. However, the urea/ammonia present in a urea solution, such as the AdBlue® solution, can attack the integrity of known rubber materials used in equipment parts used for a SCR system; and the urea solution can attack the integrity of the known bonding agents that are used to bond the rubber material to the metal substrate. Heretofore, the problem of urea/ammonia attacking the bonding agent layer used to bond rubber to metal has not been addressed. Therefore, the problem remains; and the considerable technical challenge to provide a rubber-to-metal bonding agent that is not susceptible to attack by a urea solution such as AdBlue® solution also still remains.

### SUMMARY

The present invention solves the problem of the prior art and provides a water-based bonding system that can resist attack by a urea solution when the water-based bonding system comes into contact with the urea solution. In addition, the present invention provides a water-based bonding system that can be advantageously used to combine two dissimilar materials (e.g., rubber and metal), each having significantly different chemical and physical properties, into an internal bonded unit (i.e., a composite).

One embodiment of the present invention is directed to a water-based cover adhesive composition including a combination of at least three different polymer latexes such as: (1) at least a first polymer latex, for example, a chlorosulfonated polyolefin; (2) at least a second polymer latex, for example, a brominated polydichlorobutadiene; and (3) at least a third polymer latex, for example, a chlorinated polyisoprene.

In another embodiment, the water-based cover adhesive composition of the present invention may include: (A) the three different polymer latexes described above in combination with (B) a blend of at least two different polynitroso compounds such as (1) a first polynitroso compound with a high crystallinity (e.g., crystalline polydinitroso benzene) and (2) a second polynitroso compound with a low crystallinity (e.g., an amorphous polydinitroso benzene).

In still another embodiment, the water-based cover adhesive composition of the present invention may include a cross-linking system comprising a combination of: (I) at least a first crosslinker comprising a blend of the two (first and second) different polynitroso compounds described above, and (II) at least a second crosslinker (or co-crosslinker) such as bismaleimide.

In one preferred embodiment, the water-based adhesive film-forming cover composition of the present invention may include (i) at least one film forming polymer; (ii) at least one lower crystallinity first polynitroso compound; (iii) at least one higher crystallinity second polynitroso compound; (iv) at least one crosslinking agent; and (v) water as a carrier liquid. A cover film can be formed from the above water-based adhesive film-forming cover composition.

Another embodiment of the present invention is directed to a bonding system for bonding substrates together to form a bonded unit including (a) a water-based adhesive film-forming primer component and (b) the above water-based adhesive film-forming cover composition. In still another embodiment, the present invention is directed to a process for preparing a bonding system by combining the above water-based adhesive film-forming primer component (a) and the above water-based adhesive film-forming cover component (b). The primer component (a) above can be an aqueous dispersion of: (i) one or more phenolic resins; (ii) one or more polyacrylates; (iii) one or more latices of one or more halogenated polyolefins; and (iv) one or more crosslinking agents.

Yet another embodiment of the present invention is directed to a bonded article including a metal or plastic substrate bonded to a rubber substrate. The metal or plastic substrate can be bonded to the rubber substrate by a bonding line of a bonding system disposed between at least a portion of one surface of the metal substrate and at least a portion of one surface of the rubber substrate. In this embodiment, the bonding system can include: (a) the above water-based adhesive film-forming primer component; and (b) the above water-based adhesive film-forming cover component.

Even still another embodiment of the present invention includes a process of bonding a metal or plastic substrate to a rubber substrate according to the steps of: (I) forming a layer of the above water-based adhesive film-forming primer component on at least a portion of the surface of the metal substrate; (II) forming a layer of the above water-based adhesive film-forming cover component on at least a portion of the surface of the layer of water-based adhesive film-forming primer component of step (I) to form a bonding system; and (III) disposing the bonding system comprising the water-based primer composition in combination with the water-based cover cement composition in the form of a bonding line between the surface of the metal substrate and the surface of the rubber substrate.

### DETAILED DESCRIPTION

In one preferred embodiment, the water-based cover adhesive composition of the present invention may include: (i) one or more film forming polymers such as the first, second and third polymer latexes described above; (ii) a crosslinking system such as the blend of the first and second polynitroso compounds with different crystallinities as described above; (iii) a co-crosslinker such as the aforementioned bismaleimide; and (iv) water as a carrier liquid. Other optional compounds or additives may also be included in the above cover composition. Generally, the cover composition can have a viscosity sufficiently low enough to be applied (e.g., by spraying) as a coat to a water-based primer coat.

The water-based cover in combination with a water-based primer can beneficially form a bonding system for various substrates, for example metal and rubber. This water-based two-coat bonding system includes (a) a water-based adhesive film-forming primer component; and (b) a water-based adhesive film-forming cover component. In the example of bonding substrates such as rubber to metal, the bonding system used to combine rubber and metal can also be referred to herein as a “rubber-to-metal bonding system” (abbreviated as “RtMB system”). The RtMB system of the present invention can be advantageously used in applications where the RtMB system will be in contact with a urea solution such as an AdBlue® solution. The RtMB system of the present invention passes a hot urea-solution test that makes the RtMB system beneficially useful for urea-solution applications, i.e., the above combination bonding system can be used to prepare various parts, such as rubber parts, that are subjected to contact with urea-solutions. The materials used in the RtMB system are based on suitable polymers that can withstand contact with the urea solution.

Therefore, one of the benefits of the RtMB system of the present invention is the bonding system's resistance to attack by a urea solution and/or attack by a decomposition product of a urea solution such as ammonia. Generally, the urea solution can attack the bondline of the RtMB system directly and/or by diffusion through the matrix of the rubber substrate; and the water-based bonding system of the present invention can be used to prevent such attack. It has been found that a bonding system that includes (a) a water-based primer, as a first coat, in combination with (b) a water-based cover, as a second coat, when applied onto the surface of a metal such as steel and vulcanized with an ethylene propylene diene monomer (EPDM) rubber, demonstrates excellent stability against an aqueous urea-solution at high temperatures (for example, up to 95° C.).

The water-based cover adhesive composition of the present invention may include a film-forming polymer. A “film-forming polymer” is defined herein as a polymer that forms a film when a layer of that polymer, which is dispersed or dissolved within a carrier fluid, is applied to the surface of a substrate. Generally, a layer of a waterborne composition containing a dispersed polymer can be applied to a substrate, and then the carrier fluid can be removed. The removal of carrier fluid can be conventionally carried out by drying either at room temperature (about 25° C.) or at an elevated temperature (i.e., above about 25° C., and generally from above 25° C. up to 100° C.).

Examples of suitable polymers useful as the film-forming polymer in the cover composition, which may be used alone or in combination, include, an olefin polymer, which may be substituted or unsubstituted or a mixture thereof. The olefin polymers, also called polyolefins, and suitable for use herein may include polymers based on monomer molecules that can be unsaturated aliphatic hydrocarbons containing one double bond per molecule. Examples of such olefin polymers can be polyethylene, polypropylene, polyisobutylene, polybut-1-ene, poly-4-methylpent-1-ene, and the various copolymers thereof. Also included in the class of useful polymers can be polymers based on natural rubber and polymers based on synthetic rubber such as for example polyisoprene; polybutadiene; polymers of adducts of butadiene and cyclic conjugated dienes; copolymers of butadiene and styrene; copolymers of ethylene, propylene, and dienes; copolymers of acrylonitrile and butadiene; and the various copolymers thereof. Also, the class of polymers useful in the present invention can include, for example, the polymers described above that also include one or more multi-functional monomers to provide crosslinking.

In one embodiment, the film-forming polymer in the cover coat can be typically an olefin polymer that can be halogenated. Halogenated polyolefins may have structures that can be the same as those of unsubstituted polyolefins except that halogen atoms replace one or more of the hydrogen atoms. The halogens may be chlorine, bromine, fluorine, or a mixture thereof. The preferred halogens may include chlorine, bromine, and mixtures thereof. The amount of halogen does not appear critical and can range from 3 weight percent (wt %) to 70 wt % of the polymer.

The halogenated polyolefin desirably may be a substituted polydiene polymer (i.e., a polymer that has the structure of a polydiene polymer with halogen atoms substituted for some of the hydrogen atoms). Suitable polydiene polymers include, for example, polybutadiene, polyisoprene, and mixtures thereof. Some suitable polydiene polymers useful in the present invention may be monomer units that can be residues of diene molecules. In some embodiments, substantially all halogenated olefin polymer in the adhesive composition can be a substituted polydiene polymer in which no monomer units are other than residues of diene molecules.

The halogenated polyolefin may be substituted with bromine, which is a halogenated olefin polymer in which at least one halogen is bromine. A bromine substituted olefin polymer may or may not contain atoms of halogens other than bromine. Another halogenated polyolefin may be substituted with chlorine, which is a halogenated olefin polymer in which at least one halogen is chlorine. A chlorine substituted polyolefin may or may not contain atoms of halogens other than chlorine. One specific type of chlorine substituted olefin polymer can be a chlorinated polyolefin, which can be an olefin polymer in which all the substituents are chlorine. One chlorinated polyolefin useful in the present invention can be, for example, chlorinated polyethylene (CPE).

Another example of a useful halogenated polyolefin is a mixed-halogen polyolefin, which is a halogenated polyolefin that has two or more different types of halogen atoms. In some embodiments, a mixed-halogen substituted olefin polymer is used that has chlorine and bromine. One suitable mixed-halogen substituted olefin polymer, for example, is brominated polydichlorobutadiene (“BPDCD”).

In some embodiments, at least one halogenated polyolefin is used that has no substituent on the olefin polymer selected from nitrile, carboxyl, carboxylate ester, ether, peroxyester, or combination thereof. In some embodiments, every halogenated olefin polymer has no substituent on the olefin polymer selected from nitrile, carboxyl, carboxylate ester, ether, peroxyester, or combination thereof. In some embodiments, at least one halogenated olefin polymer is used that has no substituent on the olefin polymer other than halogen. In some embodiments, every halogenated olefin polymer in the adhesive composition has no substituent on the olefin polymer other than halogen.

Another useful film forming polymer can be a halosulfonated polyolefin, which is a polymer that has the structure of unsubstituted olefin polymer in which some of the hydrogen atoms of the structure are replaced with halogen atoms and in which some of the other hydrogen atoms of the structure are replaced with sulfonyl halide groups. For example, the sulfonyl halide groups can have the chemical formula: SO₂X, where X is a halogen atom. In one embodiment, the halogens in the sulfonyl halide groups may be chlorine, bromine, fluorine, or a mixture thereof. In some embodiments, every halogen in every sulfonyl halide group of every halosulfonated olefin polymer can be either chlorine or bromine. In one preferred embodiment, every halogen in every sulfonyl halide group of every halosulfonated olefin polymer in the adhesive composition can be chlorine.

As aforementioned, a preferred embodiment of the water-based cover adhesive composition of the present invention may include: (i) at least three film forming polymers such as (1) at least a first polymer latex, for example, a chlorosulfonated polyolefin, (2) at least a second polymer latex, for example, a brominated polydichlorobutadiene, and (3) at least a third polymer latex, for example, a chlorinated polyisoprene.

The amount of film-forming polymer(s) used in the cover can be from 2 wt % to 75 wt % in one embodiment and from 5 wt % to 40 wt % in another embodiment, based on the total weight of the aqueous cover composition.

The adhesive cover composition includes two polynitroso compounds wherein at least one of the polynitroso compounds (“first polynitroso compound”) has a low crystallinity and wherein at least one of the other polynitroso compounds (“second polynitroso compound”) has a high crystallinity. In both of the first and second polynitroso compounds there is an amorphous component that generally has no or a minor ordered molecular structure and/or is of a very fine particulate size such that little or no order (see for example, WO2017176625) is observed. The first polynitroso compound useful in the cover composition can be a polynitroso compound having a low crystallinity form. By “low crystallinity” herein, with reference to a polynitroso compound, it is meant that the crystallinity of the compound can be at most 33 percent (%) in on embodiment and at most 30% in another embodiment. For example, in one preferred embodiment, the low crystallinity first polynitroso compound may be poly-(1,4-phenyleneazine N,N-dioxide) (p-PDNB). Generally, the low crystallinity p-PDNB may have a crystallinity of at most 33% in one embodiment. Typically, the low crystallinity p-PDNB may have a crystallinity of at most 30% in another embodiment.

In one embodiment, the first polynitroso compound can be an aromatic hydrocarbon containing at least two nitroso groups attached directly to non-adjacent nuclear carbon atoms. By “nuclear” carbon atom it is meant a carbon atom that is part of an aromatic ring. Suitable aromatic compounds may have 1 to 3 aromatic nuclei, including fused aromatic nuclei. Suitable polynitroso compounds may have 2 to 6 nitroso groups attached directly to non-adjacent nuclear carbon atoms. Also, the class of polynitroso compounds can include the substituted polynitroso compounds, in which one or more hydrogen atoms attached to nuclear carbon atoms can be replaced with organic or inorganic substituent groups, such as for example alkyl, alkoxy, cycloalkyl, aryl, aralkyl, alkaryl, arylamine, arylnitroso, amino, halogen, and mixtures thereof. In some embodiments, a composition of the present invention may contain one or more polynitroso compounds with 2 nitroso groups.

Among embodiments in which one or more polynitroso compound is used, some suitable polynitroso compounds can have the following chemical Formula (I):

Rₘ—Ar—(NO)₂, Formula (I)

where Ar, in the above Formula (I), can be phenylene or naphthalene; R can be a monovalent organic radical having 1 to 20 carbon atoms, an amino group, or a halogen; and m can be 0, 1, 2, 3, or 4. If m is greater than 1, the m R groups may be the same or different from each other. R can be, in some embodiments, an alkyl, cycloalkyl, aryl, aralkyl, alkaryl, arylamine, or alkoxy radical with 1 to 20 carbon atoms; or R can be, in some embodiments, an alkyl group with 1 to 8 carbon atoms. Independently, in some embodiments, the value of m can be zero.

Some examples of suitable polynitroso compounds useful in the present invention may include m-dinitrosobenzene; p-dinitrosobenzene; m-dinitrosonaphthalene; p-dinitroso-naphthalene; 2,5-dinitroso-p-cymene; 2-methyl-1,4-dinitrosobenzene; 2-methyl-5-chloro-1,4-dinitrosobenzene; 2-fluoro-1,4-dinitrosobenzene; 2-methoxy-1,3-dinitrosobenzene; 2-benzyl-1,4-dinitrosobenzene; 2-cyclohexyl-1,4,-dinitrosobenzene; and mixtures thereof. In some embodiments, the one or more polynitroso compound used may be selected from dinitrosobenzenes, substituted dinitrosobenzenes, dinitrosonaphthalenes, substituted dinitrosonaphthalenes, and mixtures thereof.

Also, the class of polynitroso compounds can include compounds as described above which exist in polymeric form; and as described in U.S. Pat. Nos. 4,308,365, and 5,478,654. In some embodiments, the one or more polynitroso compounds used may be selected from the polymeric form of p-dinitroso-benzene, the polymeric form of 1,4-dinitrosonaphthalene, and mixtures thereof. In some embodiments, the polymeric form of 1,4-dinitrosobenzene can be used in the present invention.

The second polynitroso compound useful in the cover composition can be a polynitroso compound having a high crystallinity form. By “high crystallinity” herein, with reference to a polynitroso compound, it is meant that the crystallinity of the compound can be at least 33% by weight of the total weight of the compound in one general embodiment, at least 35 wt % in another embodiment, 40 wt % in still another embodiment, and 45 wt % in yet another embodiment. For example, in one preferred embodiment, the high crystallinity second polynitroso compound may be a high crystallinity p-PDNB. Generally, the high crystallinity p-PDNB may have a crystallinity of at least 33% by weight of the total weight of the p-PDNB in one embodiment. Typically, the high crystallinity p-PDNB may have a crystallinity of at least 35 wt % in another embodiment, 40 wt % in still another embodiment, and 45 wt % in yet another embodiment. Regardless of the particular crystallinities of the p-PDNB, the ratio of the crystallinity of the high crystallinity p-PDNB to the low crystallinity p-PDNB can be at least 1.25 in one embodiment, 1.5 in another embodiment, and 1.75 in still another embodiment.

In a particular embodiment, each of the first and second polynitroso compounds present in the adhesive composition can be selected from the polymeric form of p-dinitrosobenzene, the polymeric form of 1,4-dinitrosonaphthalene, and mixtures thereof, wherein at least one polynitroso compound has a higher crystallinity and at least another polynitroso compound has lower crystallinity. In a preferred embodiment, each of the polynitroso compounds present in the adhesive composition can be the polymeric form of p-dinitrosobenzene, in which the polymeric form of p-dinitrosobenzene can be present in a lower crystallinity form and a higher crystallinity form. Desirably, the lower crystallinity polynitroso compound and the higher crystallinity polynitroso compound may be provided in a weight ratio of ½ to 2/1 in one embodiment, and 1.1/1 to 1/1.1 in another embodiment.

As aforementioned, one preferred embodiment of the water-based cover adhesive composition of the present invention may include a crosslinking system comprising a blend of at least two different polynitroso compounds such as (1) a first polynitroso compound with a high crystallinity (e.g., crystalline polydinitroso benzene) and (2) a second polynitroso compound with a low crystallinity (e.g., an amorphous polydinitroso benzene). The first and second polynitroso compounds useful in the present invention can be, for example, the polynitroso compounds described in WO2017176625.

In another embodiment, the water-based cover adhesive composition of the present invention may include at least one co-crosslinker compound used with the above blend of crosslinkers. The cover coat aqueous composition further includes one or more bismaleimide-containing monomers or polymers. In one embodiment, a bismaleimide-containing monomer or polymer can be a bismaleimide-containing monomer having the following chemical Formula (II):

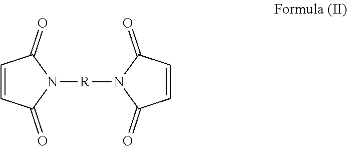

wherein R, in the above Formula (II), can be alkyl, aryl, mixed alkyl-aryl hydrocarbons, or one or more maleimide units. Suitable one or more bismaleimide-containing monomers include, for example, N,N′-ethylene-bismaleimide, N,N′-hexamethylene-bismaleimide, N,N′-meta-phenylene-bismaleimide, N,N′-para-phenylene-bismaleimide, N,N′-4,4′-biphenylene-bismaleimide, N,N′-4,4′-diphenylmethane-bismaleimide, N,N′-4,4′-(diphenyl ether)-bismaleimide, N,N′-4,4′-(diphenyl sulfide)-bismaleimide, N,N′-m-phenylenebismaleimide, 4,4′-diphenylmethanebismaleimide, N,N′-(4-methyl-m-phenylene)-bismaleimide, polyphenylmethane bismaleimide, N,N′-4,4′-diphenylsulfone-bismaleimide, N,N′-4,4′-dicyclohexylmethane-bismaleimide, N,N′-α,α-4,4′-dimethylenecyclohexane-bismaleimide, N,N′-meta-xylylene-bismaleimide, N,N′-para-xylylene-bismaleimide, N,N′-4,4′-(1,1-diphenylcyclohexane)-bismaleimide, N,N′-4,4′-diphenylmethane-bischloromaleimide, N,N′-4,4′-(1,1-diphenylpropane)-bismaleimide, N,N′-4,4′-(1,1,1-triphenylethane)-bismaleimide, N,N′-4,4′-triphenylmethane-bismaleimide, N,N′-3,5-triazole-1,2,4-bismaleimide, N,N′-dodecamethylene-bismaleimide, N,N′-(2,2,4-trimethylhexamethylene)-bismaleimide, N,N′-4,4′-diphenylmethane-biscitraconimide, 1,2-bis-(2-maleimidoethoxy)-ethane, 1,3-bis-(3-maleimidopropoxy)-propane, N,N′-4,4′-benzophenone-bismaleimide, N,N′-pyridine-2,6-diyl-bismaleimide, N,N′-naphthylene-1,5-bismaleimide, N,N′-cyclohexylene-1,4-bismaleimide, N,N′-5-methylphenylene-1,3-bismaleimide and N,N′-5-methoxyphenylene-1,3-bismaleimide. The bismaleimide-containing monomer can be prepared by utilizing methods known in the art, for example, U.S. Pat. No. 3,018,290.

In general, the one or more bismaleimide-containing monomers or polymers can be present in the cover coat aqueous composition in an amount of 0 wt % to 15 wt %, based on the total weight of the first aqueous composition. In one embodiment, the one or more bismaleimide-containing monomers or polymers can be present in the first aqueous composition in an amount of 0 wt % to 10 wt %, based on the total weight of the first aqueous composition. The amount of co-crosslinker(s) used in the cover can be from 0 wt % to 15 wt % in one embodiment, from 0.01 wt % to 10 wt % in another embodiment, and from 0.1 wt % to 7 wt % in still another embodiment.

In one preferred embodiment, the carrier fluid useful in the water-based cover composition of the present invention is water. In another embodiment, the cover adhesive composition of the present invention may contain surfactants to disperse one or more components of the adhesive composition and such surfactants can be particularly useful when water is the carrier liquid. The surfactant may be any useful surfactant for dispersing one or more of the components in the water such as an amphoteric, anionic, cationic, anionic, or nonionic surfactant; and mixtures thereof. Typically, the surfactant can be anionic, nonionic, or mixture thereof. Some suitable nonionic surfactants useful in the present invention can include, for example, alkoxylates, copolymers of ethylene oxide, propylene oxide, and mixtures thereof. Among the suitable alkoxylates are, for example, ethoxylates, having the following chemical Formula (III):

R—O—(—CH₂CH₂O—)ₓ—H Formula (III)

where R, in the above Formula (III), can be an aliphatic group, an aromatic group, an aliphatic-substituted aromatic group, and aromatic-substituted aliphatic group, or a mixture thereof; and x can be from 5 to 200. In some embodiments, R can be an alkyl-substituted benzene with the structure R1-R2-, where R1 may be a linear alkyl group and R2 may be an aromatic ring. In one preferred embodiment, the suitable nonionic surfactant useful in the present invention may be nonylphenol ethoxylate.

Among embodiments in which a nonionic surfactant is used, some suitable amounts of nonionic surfactant can be, for example, 1 wt % or more in one embodiment; 5 wt % or more in another embodiment; and 8 wt % or more in still another embodiment. Independently, among embodiments in which nonionic surfactant is used, some suitable amounts of nonionic surfactant can be, for example, 30 wt % or less in one embodiment; 20 wt % or less in another embodiment; and 15 wt % or less in still another embodiment. In some embodiments, the amount of nonionic surfactant in the composition of the present invention can be 0.1 wt % or less in one embodiment; and 0.01 wt % or less in another embodiment. The above weights are dry weights such that it precludes any weight of the carrier liquid (e.g., water).

In some embodiments, the cover adhesive composition contains one or more anionic surfactants. Among embodiments in which an anionic surfactant is used, some suitable amounts of anionic surfactant can be, for example, 1 wt % or more in one embodiment; 5 wt % or more in another embodiment; and 8 wt % or more in still another embodiment. Independently, among embodiments in which an anionic surfactant is used, some suitable amounts of anionic surfactant can be, for example, 30 wt % or less in one embodiment; 20 wt % or less in another embodiment; and 15 wt % or less in still another embodiment. In some embodiments, the amount of anionic surfactant in the composition of the present invention can be 0.1 wt % or less in one embodiment and 0.01 wt % or less in another embodiment. In some embodiments, no anionic surfactant may be present.

In another embodiment, the water-based cover adhesive composition of the present invention may include other known cover adhesives and/or commercially available cover adhesives. Exemplary of known cover adhesives that can be useful in the present invention may include the adhesive compositions described in WO2017176625. Exemplary of commercial adhesive covers useful in the present invention may include for example MEGUM W 23126, MEGUM W 23803; MEGUM W 9100, MEGUM W 9200, and/or MEGUM W 9500 available from The Dow Chemical Company.

In another embodiment, the present invention includes a bonding system comprising a bonding system for bonding substrates together to form a bonded unit comprising a combination of (a) a water-based adhesive film-forming primer composition and (b) the water-based adhesive film-forming cover composition described above. The water-based adhesive film-forming primer composition (a) can include an aqueous dispersion of: (i) one or more phenolic resins; (ii) one or more polyacrylates; (iii) one or more latices of one or more halogenated polyolefins; and (iv) one or more crosslinking agents.

The bonding system of the present invention beneficially passes a hot urea-solution test. In addition, the bonding system is advantageously stable against attack on the bonding system's integrity by an aqueous urea-solution when the bonding system is in contact with the aqueous urea-solution at temperatures of, for example, up to about 95° C.

As aforementioned, the water-based film-forming primer adhesive composition can be an aqueous dispersion of: (i) one or more phenolic resins; (ii) one or more polyacrylates; (iii) one or more latices of one or more halogenated polyolefins; and (iv) one or more crosslinking agents.

The film-forming primer adhesive composition can be a water-based adhesive containing an aqueous dispersion of one or several phenolic resins, which has been stabilized by one or several polyacrylates, one or several latices of one or several halogenated polyolefins and one or several crosslinking agents. Exemplary of the primer adhesive used in the present invention can be any one or more of the primer adhesives described in U.S. Pat. No. 5,962,576. The process of formulating the water-based primer adhesive is also disclosed in U.S. Pat. No. 5,962,576 (equivalent to DE 19519945). Examples of a commercial primer adhesive used in the present invention can be MEGUM™ W 23500 and/or MEGUM W 9300 available from The Dow Chemical Company.

Another preferred embodiment of the present invention includes a water-based adhesive, where the aqueous dispersion of one or several phenolic resins, which has been stabilized by one or several polyacrylates, can be obtained by mixing: (a) water, (b) one or several polyacrylates, and (c) one or several phenolic resins. This water-based dispersion can thus be advantageously prepared without the use of an organic solvent. The dispersion can be prepared within a surprisingly short period and with very little effort.

Still another preferred embodiment of the present invention includes a water-based adhesive, where the phenolic resin can be a condensation product of phenols with formaldehyde. With this heat-reactive phenolic resin, good results can be achieved with respect to the adhesiveness with a small content of low-molecular, hydroxyl-containing, organic compounds. A particularly preferred embodiment of the present invention can be a water-based adhesive, where the phenolic resin can be a resol and/or a novolak resin. With this heat-reactive phenolic resin, very good results can be achieved with respect to the adhesiveness with a very small content of low-molecular, hydroxyl containing, organic compounds.

Another preferred embodiment of the present invention includes a water-based adhesive, where at least one phenolic resin can be hydrophobic. With this phenolic resin, excellent results can be achieved with respect to the adhesiveness with a negligibly small content of low-molecular, hydroxyl-containing, organic compounds.

A preferred embodiment of the present invention is a water-based adhesive, where the polyacrylate can be an alkali or ammonium salt of a polyacrylic acid and/or a substituted polyacrylic acid. With these dispersion-stabilizing polymers, the best results can be achieved in the stabilization of the phenolic resin dispersion. The addition of dispersing agents such as emulsifiers, cross-linking agents and/or de-foaming agents as well as polyvinyl acetate and/or partly saponified polyvinyl acetate is also advantageous in providing an improved water-based adhesive.

The substituted polyacrylic acid may be a polymerizate or secondary product of monomers with the following general Formula (IV):

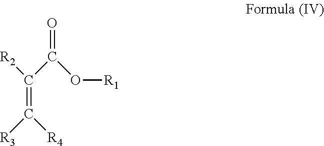

where in the above Formula (IV) each R₁ can be H, CH₃, an alkyl group of C₂ to C₄ carbon atoms, or an aryl group; each R₂ can be H, OH, CN, CH₃, an alkyl group of C₂ to C₈ carbon atoms, F, Cl, or Br; and each R₃ and each R₄ can be H, CH₃, an alkyl group of C₂ to C₈ carbon atoms, an aryl group, O—CH₃, an O-alkyl group of C₂ to C₈ carbon atoms, or an O-aryl group.

As aforementioned, the water-based film-forming primer adhesive composition of the present invention includes one or more latices of one or more halogenated polyolefins as component (iii). The one or more latices can include an emulsion, dispersion or suspension of one or several halogenated polyolefins in water. For example, the halogenated polyolefins useful in the primer composition may include chloroprene polymer. Using the primer composition of the present invention, it is advantageously possible to use a high molecular weight (e.g., up to 500,000 Daltons (g/mol) chloroprene polymer dispersed in water. Other high molecular chloroprene polymers useful in the present invention are described, for example, in Encyclopedia of Polymer Science and Technology “CHLOROPRENE POLYMERS”, 2005, John Wiley & Sons, Inc. Solvent-based primers typically use mostly chlorinated polyisoprene having molecular weights of from 20,000 Daltons to 200,000 Daltons and such prior art solvent-based primers do not work adequately in the present invention.

In one preferred embodiment, the aforementioned one or more latices may be a latex with one or several halogenated polyolefins useful in the water-based primer composition of the present invention, can include an emulsion copolymer of 2-chloro-butadiene and methacrylic acid. When the above halogenated polyolefins are used in the primer composition in an embodiment, the chlorine content of the primer composition can be from 35% to 50%, and the content of comonomers can be from 0.1% to 5%, based on the solid polymer in the latex. The best results can be achieved for adhesiveness and film formation using the above halogenated polyolefins in the primer composition.

One of the benefits of using the water-based film-forming primer adhesive composition of the present invention is that the primer composition has a neutral pH. For example, when a chloroprene latex is used, the pH primer composition can be from 5.5 to 8.5 in one embodiment and from 6 to 8 in another embodiment.

A preferred embodiment of the present invention includes a water-based adhesive, where the cross-linking agent can be one or several oxides of one or several polyvalent metals. With these cross-linking agents, good results can be achieved for the adhesiveness and the corrosion resistance.

A preferred embodiment of the present invention can be a water-based adhesive, where the cross-linking agent may consist of one or several oxides of the metals Mg, Al, Ca, Zn, Zr, Cd and Pb. With these metal oxides very good results can be achieved for the adhesiveness and the corrosion resistance.

A preferred embodiment of the present invention includes an adhesive primer composition which on 100 parts of one or several halogenated polyolefins contains 0.1 parts to 80 parts of one or several polyacrylates, 50 parts to 500 parts of one or several phenolic resins and 1 parts to 100 parts of one or several cross-linking agents. In accordance with the present invention, “parts” are parts by weight. With this composition a particularly high adhesive force of the adhesive can be achieved. In addition, 30 parts to 300 parts of pigment and/or soot may be added to the adhesive composition. The dry matter content of the aqueous suspension can be from 17 wt % to 65 wt % in one embodiment.

The adhesive compositions may contain surfactants to disperse one or more components of the adhesive composition and are particularly useful when water is the carrier liquid. The surfactant may be any useful surfactant for dispersing one or more of the components such as an amphoteric, anionic, cationic, anionic or nonionic surfactant. Typically, the surfactant may be anionic, nonionic or mixture of these. Some suitable nonionic surfactants useful in the present invention can be, for example, alkoxylates; copolymers of ethylene oxide and propylene oxide; and mixtures thereof. In one preferred embodiment, the suitable alkoxylates can be, for example, ethoxylates, which have the structure:

R—O—(—CH₂CH₂O—)ₓ—H

where R is an aliphatic group, an aromatic group, an aliphatic-substituted aromatic group, and aromatic-substituted aliphatic group, or a mixture thereof; and x is from 5 to 200. In some embodiments R is alkyl-substituted benzene, with the structure R1-R2-, where R1 is a linear alkyl group and R2 is an aromatic ring. One suitable nonionic surfactant is nonylphenol ethoxylate.

Among embodiments in which nonionic surfactant is used, some suitable amounts of nonionic surfactant are, for example, 1 wt % or more; or 5 wt % or more; or 8 wt % or more. Independently, among embodiments in which nonionic surfactant is used, some suitable amounts of nonionic surfactant are, for example, 30 wt % or less; or 20 wt % or less; or 15 wt % or less. In some embodiments, the amount of nonionic surfactant in the composition of the present invention in 0.1 wt % or less; or 0.01 wt % or less. The weights are dry weights in that preclude any weight of the carrier liquid or water.

In some embodiments, the adhesive composition contains one or more anionic surfactant. Among embodiments in which anionic surfactant is used, some suitable amounts of anionic surfactant are, for example, 1 wt % or more; or 5 wt % or more; or 8 wt % or more. Independently, among embodiments in which anionic surfactant is used, some suitable amounts of anionic surfactant are, for example, 30 wt % or less; or 20 wt % or less; or 15 wt % or less. In some embodiments, the amount of anionic surfactant in the composition of the present invention in 0.1 wt % or less; or 0.01 wt % or less. In some embodiments, no anionic surfactant is present.

The water-based cover adhesive composition of the present invention has been described in detail above; and as aforementioned the cover composition may include: (i) one or more film forming polymers such as the first, second and third polymer latexes described above; (ii) a crosslinking system such as the blend of the first and second polynitroso compounds with different crystallinities described above; (iii) a co-crosslinker such as bismaleimide described above; and (iv) water as a carrier liquid described above.

The cover composition may also contain optional compounds or additives. For example, the optional components useful in the adhesive cover composition of the present invention may include any of the fillers known in the rubber art such as carbon black, fumed silica, clay, other inorganic particulates, and mixtures thereof. In another embodiment, the cover composition may contain an anti-corrosion pigment such as lead oxide, zinc oxide, molybdate modified zinc oxide, and mixtures thereof. And, in still another embodiment, the cover composition may contain further oxidizers if desired.

The amount of filler, anti-corrosion pigment, oxidizer, or any other optional compound that may be used in the cover composition may include, for example, from 0 wt % to 30 wt % in one embodiment, from 2 wt % to 25 wt % in another embodiment, from 5 wt % to 15 wt % in still another embodiment, and from 8 wt % to 10 wt % in yet another embodiment.

Generally, the water-based primer component and the water-based cover cement, as described above are prepared separately and the applied to the metal substrate individually, for example, by a spraying application. The compositions may be made by mixing the components of the compositions in any suitable mixing method such as those known in the art. Exemplary methods include ball milling, attrition milling, ribbon blending, high shear mixing (e.g., colloid mills) and paddle mixing.

The aqueous adhesive composition according to the present invention can be used to bond various types of rubber (also known as elastomers both in crosslinked and non-crosslinked form) in a very wide range to a rigid substrate under vulcanizing conditions. Suitable rubbers may include, for example, natural rubber; conjugated diene-based synthetic rubbers such as polyisoprene synthetic rubber (IR), polybutadiene rubber (BR), styrene-butadiene copolymer rubber (SBR), chloroprene rubber (CR) and butyl rubber (IIR); ethylene-alpha-olefin elastomers; ethylene/acrylic elastomer (AEM), polychloroprene rubber (CR), acrylonitrile butadiene rubber (NBR), hydrogenated NBR (HNBR), styrene-butadiene rubber (SBR), chlorosulfonated polyethylene (CSM, ACSM), epichlorohydrin (ECO), polybutadiene rubber (BR), polyisoprene-based elastomers (e.g., IR, IIR, CIIR, and BIIR), chlorinated polyethylene (CPE), brominated polymethylstyrene-butene copolymers, styrene-butadiene-styrene (SBS) and styrene-ethylene-butadiene-styrene (S-E-B-S) block copolymers, acrylic rubber (ACM), ethylene vinyl acetate elastomers (e.g., EVM, EAM), and silicone rubber, or a combination of any two or more of the foregoing or blends thereof. Suitable ethylene-alpha-olefin elastomers may include, for example, ethylene propylene copolymers (EPM), ethylene propylene diene terpolymers (EPDM), ethylene octene copolymers (EOM), ethylene butene copolymers (EBM), ethylene octene terpolymers (EODM), ethylene butene terpolymers (EBDM) and mixtures thereof. In one embodiment, the rubber component can be natural rubber, a conjugated diene-based synthetic rubber, or both. The rubber component may be used singly or in a combination of two or more.

The vulcanization of the rubber can be conducted in the presence of a vulcanizing agent. Suitable vulcanizing agents may include, for example, sulfur, a thiuram polysulfide compound such as tetramethyl-thiuram disulfide and dipentamethylenethiuram tetrasulfide; 4,4-dithiomorpholine; p-quinonedioxime; p,p′-dibenzoquinone dioxime; cyclic sulfur imide; a peroxide, and mixtures thereof.

The rubber component may include any other combination of additives known in the art. For example, the one or more additives can include fillers such as carbon black, silica and aluminum hydroxide; antioxidants; softeners; and mixtures thereof. The rubber may be used as a composite material with particles, fibers, fabrics of various materials, and mixtures thereof.

In a preferred embodiment, the bonding system includes (a) the water-based primer, as a first coat, in combination with (b) the water-based cover, as a second coat, when applied onto the surface of a substrate such as metal (e.g. steel) and vulcanized with an EPDM rubber. For example, in a first step the primer can be applied to the substrate (e.g., steel) and then dried; and in a second step, the cover adhesive composition can be applied to the primed substrate and then dried. The rubber can then be applied to the coats of the adhesive compositions on the metal substrate and co-vulcanized with the adhesive compositions. During the vulcanization process, the rubber substrate can be bonded to the metal substrate through the two coats of the co-vulcanized adhesive compositions. Surprisingly, the present invention water-based bonding system for rubber, such as EPDM rubber, is the first known water-based bonding system combination which shows excellent resistance against aqueous urea-solution. Moreover, the bonding system of the present invention unexpectedly demonstrates excellent stability against an aqueous urea-solution at high temperatures (for example, up to 95° C.).

The bonding system formulation of the present invention produced as described above has some advantageous properties and benefits. For example, some of the properties exhibited by the bonding system formulation can include corrosion resistance, boiling water resistance, hot glycol at 100° C. for 7 days and hot aqueous urea-solution resistance.

The bonding agent made in accordance with the present invention can be useful in bonding two dissimilar substrates together to form a composite article. In one preferred embodiment, the bonding system formulation of the present invention can be used to bond a rubber substrate to a metal substrate forming a rubber-to-metal composite product after the bonding system is cured. For example, in one embodiment a high-performance, water-based, two-coat, rubber-to-metal, bonding system including (a) a water-based primer (for example, Primer MEGUM W 23500); and (b) a water-based cover cement (for example, MEGUM W 9500). The bonding line made from the bonding system composition of the present invention and disposed between the metal and rubber substrates demonstrates excellent stability against an aqueous urea-solution (for example, AdBlue) at temperatures of up to 95° C.

When bonding the substrate to the rubber, the adhesive composition may be applied to the substrate by any suitable means such as spraying, dipping or brushing. Then the carrier liquid can be removed by any suitable method such as by allowing the composition to dry at ambient conditions or by heating the composition to a sufficiently high temperature to provide drying but below a temperature where the adhesive composition can react (or vulcanize). Typical temperatures for drying useful in the present invention may be from 25° C. to 100° C. in one embodiment. Any suitable time for drying the composition may be used; and such drying time can be readily determined by those skilled in the art. Exemplary drying times may be from a few minutes (min) to several days. In another embodiment, a vacuum or a flowing atmosphere may be used to facilitate quicker drying of the composition (i.e., to remove the carrier liquid).

The assemblage of the substrate, rubber and interposed adhesive composition can then be heated to a temperature for a time sufficient to vulcanize the rubber and adhesive composition thereby bonding the rubber to the substrate. The temperature may be any suitable temperature depending on the rubber being used and desired properties, which can be readily determined by those skilled in the art. The time likewise, may be any suitable time depending on the rubber used and desired properties. An applied pressure may also be employed as desired. Illustrative of typical temperatures for vulcanization can be from 120° C. to 250° C. in one embodiment and from 140° C. to 200° C. in another embodiment. The time period at the above temperatures may be for 2 seconds in one embodiment, for 3 seconds in another embodiment, or for several days in still another embodiment, depending on the particular application and depending on the size of the particular assemblage.

The rubber-to-metal product made in accordance with the present invention advantageously has several advantageous properties and benefits compared to known rubber-to-metal products. For example, when the rubber-to-metal product of the present invention is used in applications wherein the rubber-to-metal product will be in contact with a urea solution, the rubber-to-metal product of the present invention exhibits a resistance to the attack by the urea solution and/or attack by the decomposition products of the urea solution such as ammonia. In turn, the bonding line maintains its integrity and stability while in contact with the urea solution.

The effectiveness of the adhesive compositions of the present invention can be tested by bonding metal DIN strips and testing the bonded strips according to the peel test procedure described in ASTM Test D429—Method B; and the fracture pattern in the rubber can be determined as a percentage (%) of rubber retention value (herein “% R”) on the surface of the strips by visual assessment. For example, in one general embodiment, the stability performance property of the rubber-to-metal product of the present invention, can be measured by fracture pattern in % R after 7 days at 95° C. In a preferred embodiment, the stability can be from 80% R to 100% R.

The rubber-to-metal product using the bonding system of the present invention may be used, for example, in applications where the rubber-to-metal product may be in contact with an aqueous urea-solution (e.g., AdBlue) having a concentration of urea of up to 32.5 wt % and where the rubber-to-metal product and aqueous urea-solution may be subjected to high temperatures of up to 95° C. In one preferred embodiment, the rubber-to-metal product can be used for SCR applications where a reduction in nitrogen is present in a SCR system's exhaust.

### EXAMPLES

The following examples are presented to further illustrate the present invention in detail but are not to be construed as limiting the scope of the claims. Unless otherwise stated all parts and percentages are by weight.

The various ingredients used in the following Examples and Comparative Examples are described in Table I.

TABLE I

| Ingredient | Description | Supplier |
|---|---|---|
| Neoprene 115 | Polychloroprene latex (ca. 47% in | DuPont |
| | water): a copolymer latex of 2- | |
| | chlorobutadiene and methacrylic acid | |
| PPDNB 2A 50W | p-PDNB: poly-(1,4-phenyleneazine | Lord Feinchemie GmbH |
| or 1A 50W | N,N-dioxide). | |
| PPDNB C 50W | p-PDNB: poly-(1,4-phenyleneazine | Lord Feinchemie GmbH |
| | N,N-dioxide). | |
| Homide 121G | 4,4′-diphenylmethanebismaleimide | HOS-Technik GmbH |
| Intermediate | Polymer latex based on brominated 2,3 | The Dow Chemical |
| polymer latex | dichlorobutadiene (ca. 40% in water) | Company |
| Pergut latex | chlorinated polyisobutylene | The Dow Chemical |
| | | Company |
| Thixon B-4 | Chlorosulfonated polyolefin latex | The Dow Chemical |
| | (ca. 30% in water) | Company |
| Bakelite | Resol (H₂O < 5 wt %): a phenolic resol | Hexion |
| Igepal | Nonyl phenol ethoxylate: a nonionic | Solvay |
| | surfactant | |
| Propetal | Fatty alcohol polyalkylene glycol ether: | Zschimmer&Schwarz |
| | a surfactant | |

### Synthesis Example 1—Preparation of Water-Based Primer Formulation

Table II describes the recipe for preparing a water-based primer, labeled as Synthesis Example 1 (Syn. Ex. 1), used in the Inventive Examples (Inv. Ex.) which follow; and for preparing samples for testing. The primer was prepared according to the procedure described in “Example 1” disclosed in German Patent DE 19519945 (equivalent to U.S. Pat. No. 5,962,576).

TABLE II
Water-Based Primer Formulation

| Bonding System | Syn. Ex. 1 |
|---|---|
| Componnent | (g) |
| Copolymer latex of 2-chlorobutadiene and methacrylic acid | 16 |
| Resol (H₂O < 5 wt %), stabilized with sodium polyacrylate | 19 |
| ZnO | 1.5 |
| ZrO₂ | 2.2 |
| Surfactant | 0.35 |
| Carbon black | 1.2 |
| TiO₂ | 5.8 |
| Silicic acids | 1.6 |
| Deionized water | 52.35 |

### Synthesis Example 2—Preparation of Water-Based Cover Formulation

Table III describes the recipe for preparing a water-based cover cement, labeled as Synthesis Example 2 (Syn. Ex. 2), used in the Inventive Examples (Inv. Ex.) which follow; and for preparing samples for testing. The cover cement was prepared according to the procedure described in “Examples 2-4” disclosed in WO2017176625.

TABLE III
Water-Based Cover Formulation

| Bonding System | | Syn. Ex. 2 |
|---|---|---|
| Component | Description | (g) |
| PPDNB lower crystallinity | solid cross linker | 9.6 |
| PPDNB higher crystallinity | solid cross linker | 14.4 |
| Heucophos ZPA | filler | 5.4 |
| Carbon black | filler | 5.4 |
| Homide 121G | cross linker | 4.1 |
| Special black 5 | filler | 1.8 |
| ZnO | filler | 5.4 |
| surfactant | | 3.2 |
| Deionized water | water | 156 |
| Intermediate polymer latex | polymer latex based on brominated 2,3 | 11.8 |
| | dichlorobutadiene (Br-DCB) | |
| Pergut latex | chlorinated polyisobutylene | 11.8 |
| Thixon B-4 | chlorosulfonated polyolefin (CSM) latex | 71.0 |

### Test Measurements

### Peel Test

Rubber-to metal bonded parts made in accordance with primer (Syn. Ex. 1) and cover cement (Syn. Ex. 2) above were used to test for peel strength. After curing (vulcanization) to form the bonded parts, the peel strength of the bonded parts was tested according to the peel test procedure described in ASTM Test D429-Method B (2014).

Samples of the bonded parts used to perform the peel test were prepared as follows: steel strips (DIN ISO 813) 25 mm+0.5 mm in width, and 60 mm+1 mm in length; bonded area of 25 mm by 25 mm were cleaned and grit blasted. The metal surface of the steel strips were preheated (at a temperature of from 40° C.-80° C.) and then the metal surface was primed with the water-based primer formulation of Syn. Ex. 1 by spraying the primer formulation onto the metal surface to form a primer layer thereon having a thickness of from 10 μm to 20 μm. The primer layer on the metal surface was dried at 80° C. for 15 min. Then, the primed steel parts were coated with the adhesive composition, i.e., the water-based cover formulation of Syn. Ex. 2 by spraying the cover formulation onto the primer layer such that a coated layer is formed on the metal surface having a thickness of from 15 μm to 40 μm. The coated layer on the metal surface was dried again at 80° C. for 8 min. The coated steel strips were then bonded to an EPDM rubber by compression molding the rubber on the coated metal parts at 180° C. (a heated vulcanization press was used) for 8 min.

Bonded parts using the bonding system of the present inventon are pulled to destruction after curing (vulcanization) according to the peel test procedure described in ASTM Test D429-Method B.

### Fracture Pattern

Samples of the bonded parts used to perform the fracture pattern test were prepared as described above for the peel strength. The fracture pattern of the bonded parts in terms of rubber retention % (“% R”) was determined by visual assessment.

### Inventive Example 1 and Comparative Example A

The characteristic peel test of bonded parts to determine the initial bonding occurred after cooling some of the test samples over night at room temperature. Other bonded parts were used for stability testing against 32.5 wt % solution of urea (AdBlue). The aqueous solution of urea in the concentration of 32.5% is a eutectic mixture widely used in mobile urea SCR.

The resistance test against 32.5 wt % aqueous urea-solution occurred in a closed polypropylene-bottle at 95° C. for 7 days in a drying oven. In urea solution, aged parts were washed with deionized water and dried at ambient air before pulling to destruction (in accordance with the peel test procedure ASTM Test D429-Method B). The resultant bonding characteristics of adhesive compositions, labled as Inventive Example 1 (Inv. Ex. 1) and Comparative Example A (Comp. Ex. A); before and after the resistance test are described in Table IV.

TABLE IV
Media Resistance (32.5 wt % Aqueous Urea Solution)

| | | Comp. Ex. A |
|---|---|---|
| | Inv. Ex. 1 | Syn. Ex. 1/MEGUM W |
| TEST MEASUREMENT | Syn. Ex. 1/Syn. Ex. 2 | 23803 |
| Peel Strength [N/mm] - Initial | 9.2 | 11.9 |
| Bonding | | |
| Fracture pattern in rubber [% R] - | 100 | 100 |
| Initial Bonding | | |
| Peel Strength [N/mm] - Urea- | 11.0 | 9.4 |
| solution aging | | |
| (after 7 days at 95° C.) | | |
| Fracture pattern in rubber [% R] - | 96 | 80 |
| Urea-solution aging (after 7 days at | | |
| 95° C.) | | |

The results of the tests on the bonded parts, made of steel, EPDM rubber and water-based bonding system of Syn. Ex. 1 and Syn. Ex. 2 (Inv. Ex. 1), show that the bonded parts have an excellent stability against an aqueous urea-solution (e.g., AdBlue) after 7 days at 95° C. The rubber retention of the bonded parts was above 95% and the bonded parts demonstrate a good performance without remarkable damages. For comparison, the results of the tests on the bonded parts, made of steel, EPDM rubber and a known water-based primer/cover combination of Syn. Ex. 1 and MEGUM W 23803 (Comp. Ex. A), shows that the bonded parts have an 80% R which is a lower stability against an aqueous urea-solution (e.g., AdBlue) after 7 days at 95° C. Surprisingly, the water-based bonding system of the present, in combination with steel and EPDM rubber, shows excellent stability against an aqueous urea-solution (e.g., AdBlue) at high temperatures such as at a temperature of up to about 95° C.

TABLE V
Primer Performance with Controlled Pre-Condensation

| | | Syn. Ex. 1 | Syn. Ex. 1 | Syn. Ex. 1 |
|---|---|---|---|---|
| | | (after 3 days | (after 5 days | (after 12 days |
| | Syn. Ex. 1⁽¹⁾/ | at 35° C.)/ | at 35° C.)/ | at 35 ° C.)/ |
| | Syn. Ex. 2 | Syn. Ex. 2 | Syn. Ex. 2 | Syn. Ex. 2 |
| Initial bonding | 6.5 N/mm | 10.5 N/mm | 12.7 N/mm | 12.4 N/mm |
| | 100% R | 100% R | 100% R | 100% R |
| 32.5% Urea | 7.6 N/mm | 11.6 N/mm | 11.2 N/mm | 10.8 N/mm |
| (at 95° C.)⁽²⁾ | 88% R | 97% R | 98% R | 98% R |

⁽¹⁾Primer = Syn. Ex. 1
⁽²⁾It is theorized that “controlled aging” at 35° C. leads to further resin condensation and an increase in the molecular weight of the resin in the bonding agent.

What is claimed is:

1. A bonding system for bonding substrates together to form a bonded unit comprising:
(a) a water-based adhesive film-forming cover composition comprising
(i) at least one film forming polymer;
(ii) at least one lower crystallinity first polynitroso compound;
(iii) at least one higher crystallinity second polynitroso compound;
(iv) at least one co-crosslinking agent; and
(v) water as a carrier liquid,
wherein the at least one co-crosslinking agent comprises a bismaleimide-containing monomer.

2. The bonding system of claim 1, wherein the bismaleimide-containing monomer has a chemical structure of 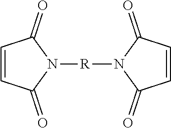
wherein R is alkyl, aryl, mixed alkyl-aryl hydrocarbons, or one or more maleimide units.

3. The bonding system of claim 1, wherein the at least one co-crosslingking agent is selected from one or more of N,N′-ethylene-bismaleimide, N,N′-hexamethylene-bismaleimide, N,N′-meta-phenylene-bismaleimide, N,N′-para-phenylene-bismaleimide, N,N′-4,4′-biphenylene-bismaleimide, N,N′-4,4′-diphenylmethane-bismaleimide, N,N′-4,4′-(diphenyl ether)-bismaleimide, N,N′-4,4′-(diphenyl sulfide)-bismaleimide, N,N′-m-phenylenebismaleimide,
4,4′-diphenylmethanebismaleimide, N,N′-(4-methyl-m-phenylene)-bismaleimide, polyphenylmethane bismaleimide, N,N′-4,4′-diphenylsulfone-bismaleimide, N,N′-4,4′-dicyclohexylmethane-bismaleimide, N,N′-α,α-4,4′-dimethylenecyclohexane-bismaleimide, N,N′-meta-xylylene-bismaleimide, N,N′-para-xylylene-bismaleimide, N,N′-4,4′-(1,1-diphenylcyclohexane)-bismaleimide, N,N′-4,4′-diphenylmethane-bischloromaleimide, N,N′-4,4′-(1,1-diphenylpropane)-bismaleimide, N,N′-4,4′-(1,1,1-triphenylethane)-bismaleimide, N,N′-4,4′-triphenylmethane-bismaleimide, N,N′-3,5-triazole-1,2,4-bismaleimide, N,N′-dodecamethylene-bismaleimide, N,N′-(2,2,4-trimethylhexamethylene)-bismaleimide, N,N′-4,4′-diphenylmethane-biscitraconimide, 1,2-bis-(2-maleimidoethoxy)-ethane, 1,3-bis-(3-maleimidopropoxy)-propane, N,N′-4,4′-benzophenone-bismaleimide, N,N′-pyridine-2,6-diyl-bismaleimide, N,N′-naphthylene-1,5-bismaleimide, N,N′-cyclohexylene-1,4-bismaleimide, N,N′-5-methylphenylene-1,3-bismaleimide and N,N′-5-methoxyphenylene-1,3-bismaleimide.

4. The bonding system of claim 3, wherein the at least one co-crosslinking agent is N,N′-4,4′-diphenylmethane-bismaleimide.

5. The bonding system of claim 1 wherein the cover composition comprises 0.01 wt. % to 10 wt. % of co-crosslinking agents based on the total weight of the cover composition.

6. The bonding system of claim 5 wherein the cover composition comprises 0.1 wt. % to 7 wt. % of co-crosslinking agents based on the total weight of the cover composition.

7. The bonding system of claim 6 wherein the cover composition comprises about 4 wt. % of the co-crosslinking agent based on the total weight of the cover composition.

8. The bonding system of claim 1 further comprising
(b) a water-based adhesive film-forming primer composition.
